(19) United States
(12) Patent Application Publication
(10) Pub. No.: US 2003/0070371 A1
(43) Pub. Date: Apr. 17, 2003

(54) Glazing assembly for window assembly

(76) Inventor: Michael D. Kobrehel, Elkhart, IN (US)

Correspondence Address: BANNER & WITCOFF LTD.,, ATTORNEYS FOR DURA AUTOMOTIVE, 28 STATE STREET - 28TH FLOOR, BOSTON, MA, 02109, US

(21) Appl. No.: 09/975,483

(22) Filed: Oct. 11, 2001

(51) Int. Cl. E06B 3/00

(52) U.S. Cl. 52/204.5

(57) ABSTRACT

A glazing assembly for a window assembly has a frame and a windowpane sized to fit within the frame. A sacrificial glazing panel substantially covers one surface of the windowpane. A self-locking seal assembly is seated in the frame, and has interlocking unitary arms and a hinged portion. The seal assembly releasably captivates the glazing panel and the windowpane within the frame. When the unitary arms are locked, the seal assembly captivates the windowpane and the sacrificial glazing. When the unitary arms are unlocked, the seal assembly captivates the windowpane but does not captivate the sacrificial glazing. When the self-locking seal assembly is folded about the hinged portion in an open position, the seal assembly does not captivate the windowpane or the sacrificial glazing.

### FIELD OF THE INVENTION

This invention relates generally to the field of window assemblies, and in particular, to seal assemblies for securing glazing within window assemblies.

### BACKGROUND OF THE INVENTION

A sacrificial glazing panel is typically a relatively inexpensive transparent sheet of material protecting a more expensive windowpane behind it. Window assemblies employing sacrificial glazing are used in mass transit vehicles, particularly buses, where vandalism and wear to the windowpanes are problems. Use of sacrificial glazing panels saves the cost and difficulty incurred with removing and replacing the complete window assembly.

U.S. Pat. No. 5,242,207 to Smith et al. discloses a window assembly with a self-locking seal assembly used to retain a sacrificial glazing against a primary glazing. Smith functions to retain the primary glazing at all times when the seal assembly is installed, allowing removal of the sacrificial glazing upon unlocking of its locking arms. Smith is limiting in that its self-locking seal assembly does not allow the primary glazing to be removed without removing the self-locking seal assembly itself. Removal and reinstallation of the self-locking seal assembly is time-consuming and, therefore, costly.

It is an object of the present invention to provide a window glazing seal assembly that reduces or wholly overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of preferred embodiments.

### BRIEF SUMMARY OF THE INVENTION

The principles of the invention may be used to advantage to provide a seal assembly that allows for removal and replacement of a sacrificial glazing as well as a primary glazing in a quick and efficient manner.

In accordance with a first aspect, a window assembly includes a frame and a windowpane sized to fit within the frame. A removable sacrificial glazing panel has a peripheral edge and substantially covers one surface of the windowpane. A self-locking seal assembly is seated in the frame, and has interlocking unitary arms and a hinged portion. The self-locking seal assembly releasably captivates the sacrificial glazing panel and the windowpane within the frame. The self-locking seal assembly captivates the windowpane and the sacrificial glazing panel when the unitary arms are locked, and captivates the windowpane but does not captivate the sacrificial glazing panel when the unitary arms are unlocked. The self-locking seal assembly does not captivate the windowpane and does not captivate the sacrificial glazing panel when the self-locking seal assembly is folded about the hinged portion in an open position.

In accordance with another aspect, a window assembly includes a frame defining a first and second channel. A windowpane is sized to fit within the frame. A removable sacrificial glazing panel has a peripheral edge. At least one self-locking seal assembly secures the windowpane to the frame and secures the sacrificial glazing panel to the windowpane. The seal assembly includes a channel glazing segment secured to the frame in the first channel, and a wedge segment positioned around the peripheral edge of the sacrificial glazing panel and secured to the frame in the second channel. The wedge segment includes a first arm segment that biases the windowpane against the frame, a second arm segment that is received in the second channel, a hinged portion connecting the first arm segment to the second arm segment, a first interlocking arm having a sealing lip and a locking lip, with the sealing lip extending from the first interlocking arm and engaging the sacrificial glazing panel, and a second interlocking arm having a receiving groove. The locking lip lockingly engages the receiving groove, thereby securing the sacrificial glazing panel to the windowpane.

In accordance with another aspect, a retrofitting kit for retrofitting a window assembly includes a transparent sheet of material and at least one wedge seal segment. The wedge seal segment includes a first leg segment adapted to be seated against a windowpane fixed in a frame and a second leg segment receivable in a channel in a frame. A hinge portion connects the first leg segment to the second leg segment. A pair of interlocking arms is movable between a locked position and an unlocked position. A first interlocking arm has a locking lip at a first end releasably seating in a receiving groove of a second interlocking arm. A sealing lip at a second end of the first interlocking arm engages and biases the sacrificial glazing panel towards the windowpane.

In accordance with yet another aspect, a window assembly includes a frame defining first and second channels. A windowpane is sized to fit within the frame. A removable sacrificial glazing panel has a peripheral edge. At least one self-locking seal assembly secures the windowpane to the frame and secures the sacrificial glazing panel to the windowpane. The seal assembly includes a channel glazing segment secured to the frame in the first channel, and receives the windowpane. A wedge segment has a first interlocking arm biasing the sacrificial glazing panel and windowpane against the frame, and a second interlocking arm connected to the first arm by a hinged portion and secured to the frame in a second channel. The first interlocking arm has a sealing finger engaging the sacrificial glazing panel and a locking finger releasably seated in a receiving groove of the second interlocking arm.

In certain preferred embodiments the interlocking arms of the self-locking seal assembly may be unitary with the rest of the seal assembly, that is, both the arms and the main body of the self- locking seal assembly may be of one-piece construction.

Each self-locking seal assembly may incorporate one or more seal segments. For example, where it is desirable to be able to remove both the sacrificial glazing panel and the windowpane, a channel glazing seal segment and at least one wedge seal segment may be employed. Moreover, in window assemblies of a generally rectangular shape, four wedge seal segments may be used such that each segment captivates one edge of the sacrificial glazing. Optionally, the wedge seal segments may have mitered ends to provide an enhanced contacting sealing surface between segment ends.

Window assemblies using sacrificial glazing panels, as disclosed here optionally can be fixed to a wall. They can be slidable or pivotably openable. In designs where the window assembly is fixed or pivotably openable, the self-locking seal assembly preferably is comprised of a channel glazing seal segment and a wedge seal segment, with the interlocking arms preferably being unitary with the wedge segment to releasably secure the sacrificial glazing to the rest of the window assembly.

In accordance with certain highly advantageous features, the window assemblies disclosed here avoid the cost and complexity associated with drilling additional holes into existing window assemblies. In accordance with another aspect, a retrofitting kit is provided for window assemblies that does not require the use of screws or welds for installing the self-locking assembly and removable sacrificial glazing panel. Such kits would include the sacrificial glazing and at least one wedge seal segment, preferably four wedge seal segments with mitered edges.

Alternatively, a single wedge seal segment could be employed, particularly in window assemblies using radius cornered frames. Additional features and advantages of various preferred embodiments will be better understood in view of the detailed description provided below.

From the foregoing disclosure, it will be readily apparent to those skilled in the art, that is, those who are knowledgeable or experienced in this area of technology, that the present invention provides a significant advance. Preferred embodiments of the glazing assembly of the present invention can provide an efficient and cost-effective manner of allowing for replacement of both sacrificial and primary glazings of window assemblies.

These and additional features and advantages of the invention disclosed here will be further understood from the following detailed disclosure of preferred embodiments.

### BRIEF DESCRIPTION OF THE DRAWINGS

FIG. 1 is an elevation view of window assembly in accordance with a preferred embodiment of the present invention.

FIG. 2 is a section view, taken along line 2-2 of FIG. 1, showing a wedge seal segment and a channel glazing segment.

FIG. 3 is a section view of an alternative embodiment of the wedge seal segment and channel glazing segment of FIG. 2.

FIG. 4 is a section view of the wedge seal segment of FIG. 3, shown in a locked open position.

FIG. 5 is an exploded perspective view of another preferred embodiment of a window assembly, showing four wedge seal segments with mitered ends cooperatively forming a generally rectangular-shaped seal assembly.

FIG. 6 is a side view of a pivotally openable window assembly in accordance with one embodiment of the present invention, shown in an open position.

FIG. 7 is a section view of another preferred embodiment of a window assembly of the present invention.

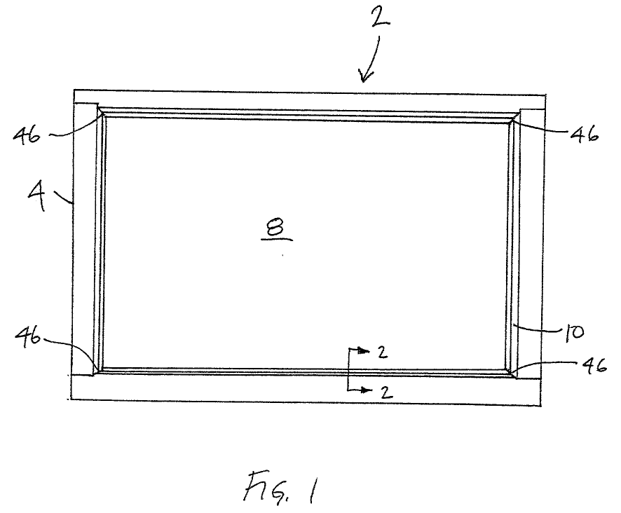

It should be understood that the appended drawings are not necessarily to scale, presenting a somewhat simplified representation of certain preferred embodiments illustrative of the basic principles of the invention. The specific design of window assemblies in accordance with the invention, including, for example, specific configuration and dimensions of the sacrificial glazing panel and the self-locking seals will be determined in part by the intended application and use environment. Certain features of the assembly have been enlarged or distorted relative to others to facilitate visualization and clear understanding. In particular, thin features may be thickened, for example, for clarity of illustration. All references to direction and position, unless otherwise indicated, refer to the orientation of the window assemblies illustrated in the drawings. In general, directions to the right and left in the plane of the paper in FIG. 1 will be referred to as lateral directions, and the directions normal to the plane of the paper in FIG. 1 shall be referred to as inboard and outboard. The directions from the periphery of the windowpane towards the center of the windowpane shall be referred to as laterally inward. It should be understood that window assemblies in accordance with the invention can be used in diverse applications.

### DETAILED DESCRIPTION OF THE INVENTION

The following discussion of certain preferred embodiments focuses on window assemblies used in mass transit vehicles, however, the design and operating principles are applicable generally to windows suitable for diverse applications. In the embodiments disclosed here, the window assembly has a generally rectangular shape, as is common in current production mass transit window designs. However, it will be readily apparent to those skilled in the art that window assemblies having alternate geometries may be employed within the scope of the invention.

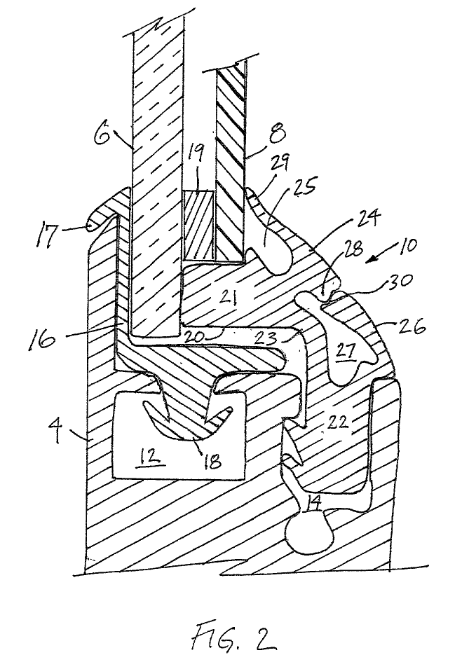

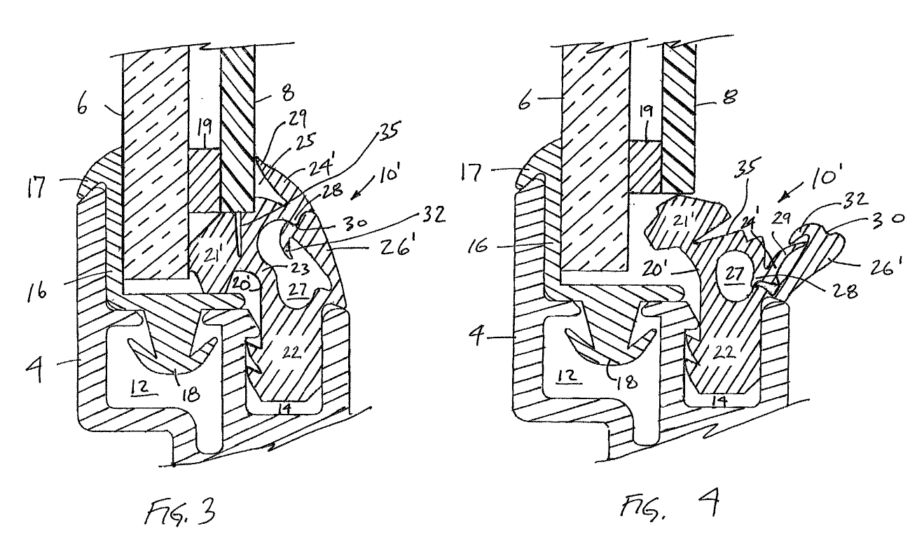

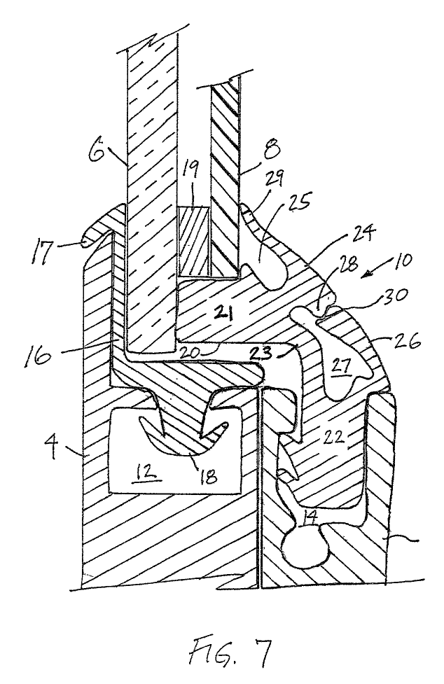

Referring now to the preferred embodiment depicted in FIGS. 1-2, a window assembly 2 in accordance with the present invention is seen to have a frame 4. In this preferred embodiment, a windowpane 6 is fixed in the frame 4. The window assembly 2, including frame 4, may be pivotable from a closed position to an open position as shown in FIG. 6, typically used as an egress window, or it may be fixed. A transparent sheet of material serves as a removable sacrificial glazing or glazing panel 8, that is, it is a part of the window assembly that, when damaged, may be easily removed without incurring the costs associated with disassembling the rest of window assembly 2. Acrylic or polycarbonate materials or other suitable transparent material may be used for the sacrificial glazing. Removable sacrificial glazing panel 8 is sized to cover at least most of one side of windowpane 6. In certain preferred embodiments, including the illustrated embodiment, sacrificial glazing panel 8 covers the interior or inboard side of windowpane 6.

In a highly advantageous feature of this invention, sacrificial glazing 8 is secured to the rest of window assembly 2 by a seal assembly 10 seated in frame 4 and mounted around the periphery of sacrificial glazing 8. Seal assembly 10 is preferably made of rubber or other similar extruded or molded material. In the preferred embodiment shown in FIG. 2, the frame 4, preferably made of extruded aluminum, has a first channel 12 and a second channel 14. Seal assembly 10 has a channel glazing seal segment 16 secured to frame 4 with a dart 18 that extends into first channel 12 in a releasably locking manner. A lip 17 on seal segment 16 rests on an upper edge of frame 4. Optionally, a spacing segment 19 may extend laterally inward between windowpane 6 and sacrificial glazing 8 to create an air gap therebetween. Spacing segment 19 may be formed of, for example, a foam tape with an adhesive on the outboard side to adhere to windowpane 6. Other suitable materials for spacing segment 19 include, for example, thermoplastic rubber, ethylene-propylene terpolymer (EPDM), any elastomeric material, rubber, or other flexible material. Other suitable materials will become readily apparent to those skilled in the art, given the benefit of this disclosure. In certain preferred embodiments, sacrificial glazing 8 may be molded, e.g., injection molded, such that spacing segment 19 is unitary with sacrificial glazing 8, that is, they are of one-piece construction.

A wedge seal segment 20 is formed of a first leg segment 21, connected to a second leg segment 22 via a hinged portion 23. In the illustrated embodiment, hinged portion 23 consists of a reduced thickness portion 23 of wedge seal segment 20. First leg segment 21 abuts windowpane 6 in a biasing manner. Second leg segment 22 extends into second channel 14, securing wedge seal segment 20 to frame 4.

Wedge seal segment 20 has a first arm 24 that interlocks with a second arm 26. First arm 24 has a sealing lip 29 that extends upwardly and sits against a surface of sacrificial glazing 8 in sealing fashion, and a locking lip 28 that extends downwardly. An air gap 25 is formed between sealing lip 29 and first leg segment 21. Second arm 26 extends upwardly to releasably engage first arm 24 when the self-locking seal arms are in their interlocking position, as shown in FIG. 2. An air gap 27 is formed between second arm 26 and second leg segment 22. Locking lip 28 seats in a receiving groove 30 of second arm 26. Second arm 26 engages first arm 24 as locking lip 28 seats in receiving groove 30 to prevent motion of second arm back to a free, unbiased position. Preferably, first arm 24 and second arm 26 are unitary, that is, they are of one-piece construction, with wedge seal segment 20. Thus, in this embodiment, a channel glazing seal segment 16 and a wedge seal segment 20 of seal assembly 10 cooperate to secure both windowpane 6 and sacrificial glazing 8 to window assembly 2.

When seal assembly 10 is in the locking position, sealing lip 29 of first arm 24 captivates and securably biases sacrificial glazing 8 towards windowpane 6, and first leg segment 21 captivates and securably biases windowpane 6 within frame 4. When first arm 24 and second arm 26 are in their unlocked position, sacrificial glazing 8 can be easily removed, without the need for removal and subsequent reinstallation of sealing assembly 10. Once sacrificial glazing 8 is removed, hinge portion 23 allows first leg segment 21 to be pivoted upwardly and inwardly. Windowpane 6 can then be easily removed and a replacement windowpane can be inserted in its place. Leg segment 21 is then bent back into its installed position, without the use of special tools.

This allows for serviceability of the windowpane, and or the sacrificial glazing panel, as in the situation where the windowpane is shattered, or the sacrificial glazing panel is damaged, or both, and need to be replaced.

One method of disassembly and removal of the sacrificial glazing is readily accomplished by using a locking tool such as CRL Locking Tool for Self-Seal Stripping, Cat. No. LT112, manufactured by CR Laurence, Inc. of Los Angeles, Calif. The locking tool has a hand-grip and an extending rod with a ball shaped end. The ball-shaped end is inserted into air gap 27 of wedge seal segment 20 defined between second arm 26 and second leg segment 22. The ball causes first arm 24 to disengage second arm 26 at that point. Then, an operator would simply move the tool along the length of the seal assembly, around the periphery of the plastic glazing, disengaging first arm 24 from second arm 26 and allowing the sacrificial glazing to be removed and a new sacrificial glazing to be installed. Installation follows the process in reverse; by moving the tool along the gap 27, locking lip 30 locks second arm 26 into locking position with first arm 24. A skilled operator can install and remove windowpane 6 and sacrificial glazing 8, and seal and lock the arms without the use of tools, using only their hands and fingers.

Another method for removing of sacrificial glazing 8 involves the use of suction cups. A pair of suction cups are adhered to sacrificial glazing 8, and with an inwardly directed force, sacrificial glazing 8 can be pulled inwardly and removed. Such a method is possible since sacrificial glazing 8 is typically a flexible plastic sheet, and since sealing lip 29 is spaced from first leg segment 21 by gap 25, providing resiliency in sealing lip 29 of first arm 24. Thus, in this removal method, no tools other than standard suction cups are required. Windowpane 6 can then be removed in the manner described above.

In the illustrated embodiment wedge seal segment 20 and channel seal segment 16 are shown as separate elements. However, it is to be appreciated that, in certain preferred embodiments, wedge seal segment 20 and channel seal segment 16 could be unitary with each other, that is, they could be of one-piece construction.

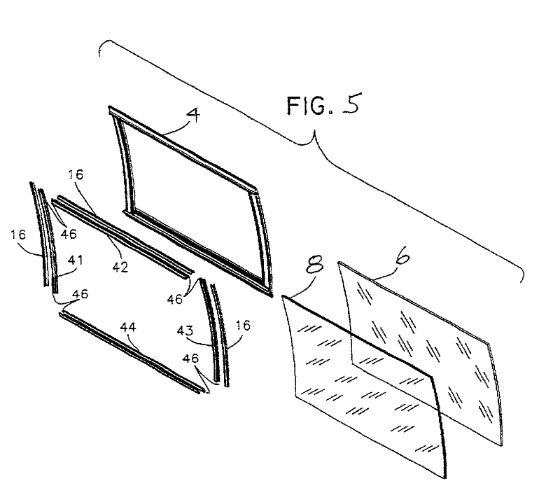

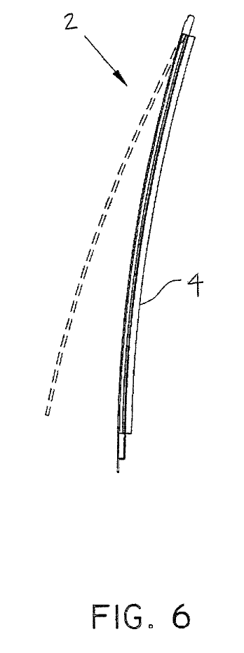

Another preferred embodiment of a seal assembly 10′ is shown in FIGS. 4-5. In this embodiment, a finger 32 extends downwardly from second arm 30. A groove 34 is formed in an upper surface of first arm segment 21′. In this embodiment, first arm 24′ can be engaged in a non-locking position with second arm 26′. When first arm 24′ and second arm 26′ are disengaged from their interlocking position and first leg segment 21′ is bent inwardly about hinge portion 23, sealing lip 29 can be engaged by finger 32, thereby allowing first arm 24 to be engaged with second arm 26′ in a non-locking position.

In certain preferred embodiments, a slit or groove 35 is formed in first arm segment 21′, providing for flexibility and bending of first arm segment 21′, and, therefore, greater ease of installation and removal of the windowpane and sacrificial glazing. With the use of groove 35, the wedge seal can be formed of a material having a higher durometer hardness, and, therefore, less flexibility, since the groove itself provides added flexibility.

Those skilled in the art will recognize that the seal assembly 10 need not completely surround the periphery of the plastic glazing, and that the seal assembly may be composed of a single channel glazing segment and a single wedge seal segment or may have multiple wedge seal segments 41-44, as is shown in FIG. 5. The ends of the seal segments provide a snug contacting sealing surface between the segment ends. Where there are multiple wedge seal segments, the ends 46 of the seal segments preferably may be mitered to provide the snug contacting sealing surface. The individual seal segments may optionally by secured to one another by an adhesive or bonding agent, to form an integrated wedge seal segment. In certain embodiments, the wedge seal segments may be molded together by means of corner molding technology, creating a unitary one-piece wedge seal.

In accordance with a retrofitting apparatus of this invention, a retrofitting kit of materials may be used to add a sacrificial glazing onto an existing window assembly. The kit of materials comprises at least one sacrificial glazing panel, one wedge seal segment, and in the case of generally rectangular window assemblies, preferably comprises four separate wedge seal segments 41-44 with mitered ends 46 each extending along one side of the sacrificial glazing panel. The mitered ends allow for each seal segment to be snug against one another, meaning surface-to-surface contact in slight compression. As seen in the preferred embodiment of FIG. 5, the retrofitting kit may optionally further comprise a replacement windowpane and channel glazing seal segments 16, for example, substantially as described above with reference to the embodiment of FIGS. 1-2.

In accordance with another embodiment of a retrofitting application of the present invention, as seen in FIG. 7, a retrofitting kit also includes a mounting rail 50 secured to frame 4 by suitable fastening means (not shown) such as screws, bolts, rivets, adhesive or any other suitable means that will adequately secure mounting rail 50 to frame 4. Channel 14 is formed in mounting rail 50 and receives second leg segment 22 as described above. Thus, in this embodiment, a vehicle that has only a single windowpane secured to the frame via a seal assembly can be retrofitted to accommodate a sacrificial glazing panel.

From the foregoing disclosure, it will be readily apparent to those skilled in the art, that is, to those who are knowledgeable or experienced in this area of technology, that the present invention provides a significant technological advance in cost, complexity reduction and in reduction of required tooling and secondary operations. Those who are skilled in this area of technology will recognize that various modifications and additions can be made to the preferred embodiments discussed above without departing from the true scope and spirit of the invention.

For example, a pair of sacrificial glazing panels could be applied, each secured by a self-locking seal assembly, one on each side of the windowpane, to protect each side. Those skilled in the art will recognize from this disclosure the suitability of other designs and configurations that also provide for a window assembly with a low-cost sacrificial glazing design. All such alternative embodiments are intended to be covered by the following claims.

It should be understood that the preferred embodiments disclosed herein are by way of example only and merely illustrative of but a small number of the many possible specific embodiments that can represent applications of the principles of the present invention. In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

I claim:

1. A window assembly comprising, in combination:
a frame;
a windowpane sized to fit within the frame;
a removable sacrificial glazing panel having a peripheral edge and substantially covering one surface of the windowpane; and
a self-locking seal assembly seated in said frame, having interlocking unitary arms and a hinged portion, the self-locking seal assembly releasably captivating the sacrificial glazing panel and the windowpane within the frame;
wherein the self-locking seal assembly captivates the windowpane and the sacrificial glazing panel when the unitary arms are locked, the self-locking seal assembly captivates the windowpane but does not captivate the sacrificial glazing panel when the unitary arms are unlocked, and the self-locking seal assembly does not captivate the windowpane and does not captivate the sacrificial glazing panel when the self-locking seal assembly is folded about the hinged portion in an open position.

2. The window assembly of claim 1, wherein the hinged portion comprises a reduced thickness portion of the seal assembly.

3. The window assembly of claim 1, wherein the self-locking seal assembly comprises a first interlocking arm having a first end releasably seating in a receiving groove of a second interlocking arm to bias the sacrificial glazing panel towards the windowpane.

4. The window assembly of claim 3, further comprising a sealing lip on the second end of the first interlocking arm that contacts and biases the sacrificial glazing panel.

5. The window assembly of claim 3, further comprising a finger on the second interlocking arm, wherein a second end of the first interlocking arm is releasably captivated by the finger to retain the self-locking seal assembly in a non-interlocked position.

6. The window assembly of claim 1, wherein the seal assembly has a channel glazing segment in which the windowpane seats and at least one wedge seal segment in which the sacrificial glazing panel seats.

7. The window assembly of claim 6, wherein the locking arms are unitary with the wedge seal segment.

8. The window assembly of claim 6, wherein the seal assembly has four wedge seal segments and each end of each wedge seal segment has a mitered surface to provide snug contact between each end of each wedge seal segment.

9. The window assembly of claim 6, wherein the wedge seal segment comprises a first arm segment biasing the windowpane against the frame, and a second arm segment received in the second channel.

10. The window assembly of claim 9, further comprising a groove formed in a surface of the first arm that abuts and engages the sacrificial glazing panel.

11. The window assembly of claim 1, further comprising a spacing segment between the windowpane and the sacrificial glazing panel to provide an air gap.

12. The window assembly of claim 1, wherein the self-locking seal assembly securably biases the sacrificial glazing panel towards the windowpane.

13. The window assembly of claim 1, wherein the seal assembly is mounted on the frame at the peripheral edge of the sacrificial glazing panel.

14. The window assembly of claim 1, wherein the seal assembly is attached to the frame and extends around the periphery of the sacrificial glazing panel and the seal assembly has a pair of ends in snug contact with one another.

15. The window assembly of claim 1, wherein the windowpane, frame and sacrificial glazing panel are slidable from a closed position to an open position.

16. The window assembly of claim 1, wherein the windowpane, frame and sacrificial glazing panel are pivotably moveable from a closed position to an open position.

17. A window assembly comprising, in combination:
a frame defining a first and second channel;
a windowpane sized to fit within the frame;
a removable sacrificial glazing panel having a peripheral edge; and
at least one self-locking seal assembly securing the windowpane to the frame and securing the sacrificial glazing panel to the windowpane, comprising;
a channel glazing segment, secured to the frame in the first channel, and
a wedge segment positioned around the peripheral edge of the sacrificial glazing panel and secured to the frame in the second channel and comprising
a first arm segment biasing the windowpane against the frame,
a second arm segment received in the second channel,
a hinged portion connecting the first arm segment to the second arm segment;
a first interlocking arm having a sealing lip and a locking lip, the sealing lip extending from the first interlocking arm and engaging the sacrificial glazing panel, and
a second interlocking arm having a receiving groove, the locking lip lockingly engaging the receiving groove, thereby securing the sacrificial glazing panel to the windowpane.

18. A retrofitting kit for retrofitting a window assembly comprising, in combination:
a transparent sheet of material; and
at least one wedge seal segment comprising:
a first leg segment configured to be seated against a windowpane fixed in a frame,
a second leg segment configured to be received in a channel in a frame;
a hinge portion connecting the first leg segment to the second leg segment;
a pair of interlocking arms movable between a locked position and an unlocked position, a first interlocking arm having a locking lip at a first end releasably seating in a receiving groove of a second interlocking arm and a sealing lip at a second end to engage and bias the sacrificial glazing panel towards the windowpane.

19. The retrofitting kit of claim 18, comprising four separate wedge seal segments, each attachable to a frame along one corresponding side of the transparent sheet, each segment having mitered ends providing snug contact between segment ends.

20. The retrofitting kit of claim 18, further comprising a mounting rail configured to be secured to a frame of a window, the second leg segment receivable in a channel formed in the mounting rail.

21. The retrofitting kit of claim 18, further comprising a windowpane and a channel glazing segment configured to be received in a second channel in a frame.

22. A window assembly comprising, in combination:
a frame defining first and second channels;
a windowpane sized to fit within the frame;
a removable sacrificial glazing panel having a peripheral edge; and
at least one self-locking seal assembly securing the windowpane to the frame and securing the sacrificial glazing panel to the windowpane, comprising a channel glazing segment secured to the frame in the first channel, and receiving the windowpane, and a wedge segment having a first interlocking arm biasing the sacrificial glazing panel and windowpane against the frame and a second interlocking arm connected to the first arm by a hinged portion and secured to the frame in a second channel, the first interlocking arm having a sealing finger engaging the sacrificial glazing panel and a locking finger releasably seated in a receiving groove of the second interlocking arm.
